(19) United States
(12) Patent Application Publication
(10) Pub. No.: US 2025/0261097 A1
(43) Pub. Date: Aug. 14, 2025

(54) PIN DISCOVERY AND COMMUNICATION IN PERSONAL IOT NETWORK

(71) Applicant: Samsung Electronics Co., Ltd., Suwon-si, Gyeonggi-do (KR)

(72) Inventors: Lalith KUMAR, Bangalore (IN); Sidhant JAIN, Chhattisgarh (IN); Aman AGARWAL, Bangalore (IN); Kailash Kumar JHA, Bangalore (IN); Anoop PERUMUDI VEEDU, Bangalore (IN)

(21) Appl. No.: 18/849,312

(22) PCT Filed: Mar. 23, 2023
(86) PCT No.: PCT/KR2023/003888

§ 371 Date: Sep. 20, 2024

(30) Foreign Application Priority Data
Mar. 25, 2022 (IN) 202241016991
Mar. 25, 2022 (IN) 202241016997
Mar. 14, 2023 (IN) 2022 41016991

(51) Int. Cl. H04W 48/18; H04W 12/08; H04W 48/08

(52) U.S. Cl. CPC H04W 48/18; H04W 12/08; H04W 48/08

(57) ABSTRACT

The disclosure relates to a 5G or 6G communication system for supporting a higher data transmission rate. Embodiments herein provide a method for PIN discovery and communication in a personal IOT network (PIN) by a PIN Element with Management Capability (PEMC). The method includes receiving a request message to join at least one PIN from a PIN Elements (PINE), determining whether the requested service or device type is supported by at least one PIN from a plurality of PINs based on the PIN information, selecting, by the PEMC, the at least one PIN from the plurality of PINs when the requested service or device type is supported by the at least one PIN form the plurality of PINs, adding the PINE to the at least one PIN to communicate the requested service or the device type, sending an accept message to the PINE.

### CROSS-REFERENCE TO RELATED APPLICATION(S)

This application is a U.S. National Stage application under 35 U.S.C. § 371 of an International application number PCT/KR2023/003888, filed on Mar. 23, 2023, which is based on and claims priority of an Indian Provisional Patent Application No. 202241016991, filed on Mar. 25, 2022, in the Indian Intellectual Property Office, an Indian Provisional Patent Application No. 202241016997, filed on Mar. 25, 2022, in the Indian Intellectual Property Office, and of an Indian Non-Provisional Patent Application Ser. No. 202241016991, filed on Mar. 14, 2023, in the Indian Intellectual Property Office, the disclosure of each of which is incorporated by reference herein in its entirety.

### TECHNICAL FIELD

The present disclosure relates to a method for selecting Personal Internet of Things (IoT) Network (PIN) based on PIN information. This application is based on and derives the benefit of Indian Provisional Application 202241016991 filed on 25 Mar. 2022 and Indian Provisional Application 202241016997 filed on 25 Mar. 2022, the contents of which are incorporated herein by reference.

### BACKGROUND ART

5G mobile communication technologies define broad frequency bands such that high transmission rates and new services are possible, and can be implemented not only in “Sub 6 GHz” bands such as 3.5 GHz, but also in “Above 6GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Solution

The principal object of the embodiments herein is to provide a method for selecting Personal Internet of Things (IoT) Network (PIN) based on PIN information. Based on the proposed methods, a PINE requesting its required services and supported services. The PEMC adds the PINE into respective PIN which supports required services (in general PIN information) and the PINE communicates with another PINE after getting added to the PIN. The PEMC stores the capability/supported services of the new PINE to be used next time by any other PINE.

Accordingly, the embodiment herein is to provide a method for PIN discovery and communication in a personal IOT network (PIN). The method includes receiving, by a PIN Element with Management Capability (PEMC), a request message to join at least one PIN from a PIN Elements (PINE). The message includes the PIN information to communicate a service or a device type supported by at least one PIN. Further, the method includes determining, by the PEMC, whether the requested service or device type is supported by at least one PIN from a plurality of PINs based on the PIN information. Further, the method includes selecting, by the PEMC, the at least one PIN from the plurality of PINs when the requested service or device type is supported by the at least one PIN form the plurality of PINs. Further, the method includes adding, by the PEMC, the PINE to the at least one PIN to communicate the requested service or the device type. Further, the method includes sending, by the PEMC, an accept message to the PINE.

In an embodiment, the accept message includes PIN Element with Gateway Capability (PEGC) information of at least one PEGC through which the PINE communicatees the requested service or device type from the at least one PIN.

In an embodiment, adding, by the PEMC, the PINE to the at least one PIN to communicate the requested service or the device type includes authorizing, by the PEMC, the PINE, adding, by the PEMC, the PINE to the at least one PIN upon successful authorization of the PINE, and storing, by the PEMC, the PIN information after adding the PINE to the at least one PIN.

In an embodiment, the PIN information includes at least one of a) supported service or device type indicating particular service supported by the PINE, b) the requested service or device type indicating the requested service that the PIN shall support and in which the PINE has to be added, c) a group identifier configured by an authorised user or a network device, wherein the group identifier indicates the request message to join the at least one PIN which supports a particular group, d) a user defined name configured by the authorized user or the network device at the PINE, wherein user defined name identifies which PIN the PINE should be added, and e) discoverability criteria, wherein the PINE is allowed to be discovered when requested for at least one of a specific service, a specific group ID, a specific user defined name, and a specific time.

Accordingly, the embodiment herein is to provide a method for PIN discovery and communication in a PIN. The method includes configuring, by a PIN Element (PINE), PIN information from a network device or an authorized user. Further, the method includes sending, by the PINE, a request message to join at least one PIN to a PEMC, wherein the message includes the PIN information to communicate a service or device type supported by at least one PIN. Further, the method includes receiving, by the PINE, an accept message confirming addition of the PINE into the at least one PIN, wherein the accept message comprises PEGC information of at least one PEGC through which the PINE communicatees the requested service or device type from the at least one PIN. Further, the method includes communicating, by the PINE, the requested service or device type from the at least one PIN through the at least one PEGC based on the PEGC information.

Accordingly, the embodiment herein is to provide a PEMC for PIN discovery and communication in a PIN. The PEMC includes a PIN discovery and communication controller coupled to a memory and a processor. The PIN discovery and communication controller is configured to receive a request message to join at least one PIN from a PINE. The message includes the PIN information to communicate a service or a device type supported by at least one PIN. Further, the PIN discovery and communication controller is configured to determine whether the requested service or device type is supported by at least one PIN from a plurality of PINs based on the PIN information. Further, the PIN discovery and communication controller is configured to select the at least one PIN from the plurality of PINs when the requested service or device type is supported by the at least one PIN form the plurality of PINs. Further, the PIN discovery and communication controller is configured to add the PINE to the at least one PIN to communicate the requested service or device type. Further, the PIN discovery and communication controller is configured to send an accept message to the PINE.

Accordingly, the embodiment herein is to provide a PINE for PIN discovery and communication in a PIN. The PINE includes a PIN discovery and communication controller coupled to the memory and the processor. The PIN discovery and communication controller is configured to configure PIN information from a network device or an authorized user. Further, the PIN discovery and communication controller is configured to send a request message to join at least one PIN to a PEMC. The message includes the PIN information to communicate a service or device type supported by at least one PIN. Further, the PIN discovery and communication controller is configured to receive an accept message confirming addition of the PINE into the at least one PIN. The accept message comprises PEGC information of at least one PEGC through which the PINE communicatees the requested service or device type from the at least one PIN. Further, the PIN discovery and communication controller is configured to communicate with the requested service or device type from the at least one PIN through the at least one PEGC based on the PEGC information.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DESCRIPTION OF DRAWINGS

The method and the PIN are illustrated in the accompanying drawings, throughout which like reference letters indicate corresponding parts in the various figures. The embodiments herein will be better understood from the following description with reference to the drawings, in which:

FIG. 1 illustrating a scenario of identification of a PIN based on service required, according to the prior arts; and

FIG. 2 illustrating a scenario of identification of the PIN based on service required, according to the embodiments as disclosed herein;

FIG. 3 illustrating a scenario of identification of the PINE to support service within the PIN, using PEGC as relay for communication between PIN Elements, according to the embodiments as disclosed herein;

FIG. 4 illustrating a scenario identification of the PINE to support service within the PINE, using direct communication between PIN Elements, according to the embodiments as disclosed herein;

FIG. 5 illustrates an overview of a PIN for handling PIN discovery and communication, according to the embodiments as disclosed herein;

FIG. 6A is a diagram illustrating a PEMC according to an embodiment of the present disclosure.

FIG. 6B shows various hardware components of a PEMC, according to the embodiments as disclosed herein,

FIG. 7A is a diagram illustrating a PINE according to an embodiment of the present disclosure.

FIG. 7B shows various hardware components of a PINE, according to the embodiments as disclosed herein;

FIG. 8 is a flow chart illustrating a method, implemented by the PEMC, for PIN discovery and communication in the PIN, according to the embodiments as disclosed herein; and

FIG. 9 is a flow chart illustrating a method, implemented by the PINE, for PIN discovery and communication in the PIN, according to the embodiments as disclosed herein.

### MODE FOR INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein. Throughout the disclosure, the expression “at least one of a, b, or c” indicates only a, only b, only c, both a and b, both a and c, both b and c, all of a, b, and c, or any variations thereof.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Below are the some of the abbreviations and terms used in the patent description:

3GPP—3rd Generation Participation Project

5GC—5G Core Network

D2D—Device to Device

FQDN—Fully Qualified Domain Name

PEGC—PIN Element with Gateway Capability

PEMC—PIN Element with Management Capability

PIN—Personal IoT Network

PIN—EPIN Element

ProSe—Proximity Services

QoS—Quality of Service

UE—User Equipment

PIN (Personal IoT Network): Personal IoT Networks (PINs) provide local connectivity between UEs and/or non-3GPP devices. A Personal IoT Network (PIN) consists of PIN Elements (PINE) that communicate using PIN Direct Connection or direct network connection and is managed locally (using a PIN Element with Management Capability).

PINE (PIN Element): PIN Elements are UEs and/or non-3GPP devices which form part of the PIN.

PEMC (PIN Element with Management Capability): PIN Element which has the capability to provide means for an authorised administrator to configure and manage a PIN. In an example, the PEMC is a normal UE that can act as a management UE.

PEGC (PIN Element with Gateway Capability): PIN Elements with Gateway Capability provide means to PIN elements to register and access 5G network services. It can also help in communication between 2 PIN elements that are not within the range to use direct communication. In an example, the PEGC is a normal UE that can act as a gateway UE.

ProSe: ProSe (Proximity Services) is a D2D (Device-to-Device) technology that allows LTE devices to detect each other and to communicate directly.

PIN-ID: Unique identifier associated with a PIN, which can help to identify the PIN.

A 5th Generation (5G) system shall enable a User Equipment (UE) or non-3GPP device in a Personal Internet of Things (IoT) Network (PIN) to discover other UEs or non-3GPP devices within the same PIN subject to access rights. The 5G system shall efficiently support service discovery mechanisms where the UE or the non-3GPP device in the PIN can discover, subject to access rights:

a) Availability and reachability of other entities (e.g. other UEs or non-3GPP devices) on the PIN;

b) Capabilities of other entities on PIN (e.g. relay UE, connection types) and/or;

c) Services provided by other entities on the PIN (e.g. the entity is a printer).

The 5G system shall support a mechanism for an Authorised Administrator to indicate whether a PIN element (PINE) is discoverable by other PIN elements of the same PIN. The 5G system shall support a mechanism for an Authorised Administrator to indicate whether the PIN element is discoverable by the UEs that are not members of the PIN. The 5G system should also support to add a PINE in the PIN or create a PIN if it's not existing.

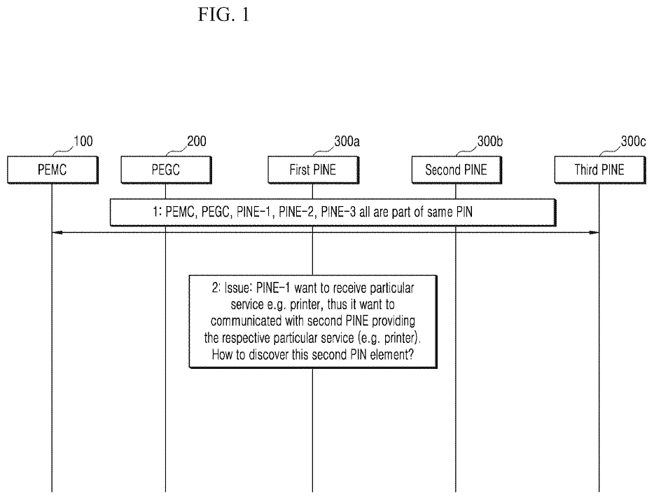

FIG. 1 illustrating a scenario of identification of a PIN based on service required, according to the prior arts.

Referring to the FIG. 1 considering the conventional methods and systems, there are multiple PINs in the environment supported by one or more PEGC and a PEMC. A first PINE (300a) wants to receive particular service e.g. printer, which PIN to join and how to join, to receive this particular respective service is not defined in the existing methods.

In an embodiment of the disclosure, as shown in FIG. 1, at 1, the PEMC (100), the PEGC (200), the first PINE (i.e., PINE-1) (300a), the second PINE (i.e., PINE-2) (300b), and the third PINE (i.e., PINE-3) (300c) are part of same PIN. The first PINE (300a) want to receive particular service e.g. printer thus it want to communicated with the second PINE (300b) providing the respective particular service (e.g. printer). But, How to discover this second PIN element (300b) is not defined in the existing methods.

Accordingly the embodiment herein is to provide a method for PIN discovery and communication in a personal IOT network (PIN). The method includes receiving, by a PIN Element with Management Capability (PEMC), a request message to join at least one PIN from a PIN Elements (PINE). The message includes the PIN information to communicate a service or a device type supported by at least one PIN. Further, the method includes determining, by the PEMC, whether the requested service or device type is supported by at least one PIN from a plurality of PINs based on the PIN information. Further, the method includes selecting, by the PEMC, the at least one PIN from the plurality of PINs when the requested service or device type is supported by the at least one PIN form the plurality of PINs. Further, the method includes adding, by the PEMC, the PINE to the at least one PIN to communicate the requested service or the device type. Further, the method includes sending, by the PEMC, an accept message to the PINE.

With the proposed solution, the requesting PINE will be able to join a PIN which can provide a service or capability required by the PINE. PEMC or any other entity maintains a list of available services (PIN Information) in the PIN. This is a list of all services provided by the member PINEs of the PIN as well as PEGC and PEMC. This information can be used when a new PINE wants to join a PIN providing a particular service, or a member PINE requests endpoint information of a PINE providing a particular service. With this information stored at the respective entities, it will be able to take such decisions (like deciding which PIN the PINE must be joined to) without multiple message exchanges between different members of PIN. Thus the solution can provide multiple advantages over the existing methods

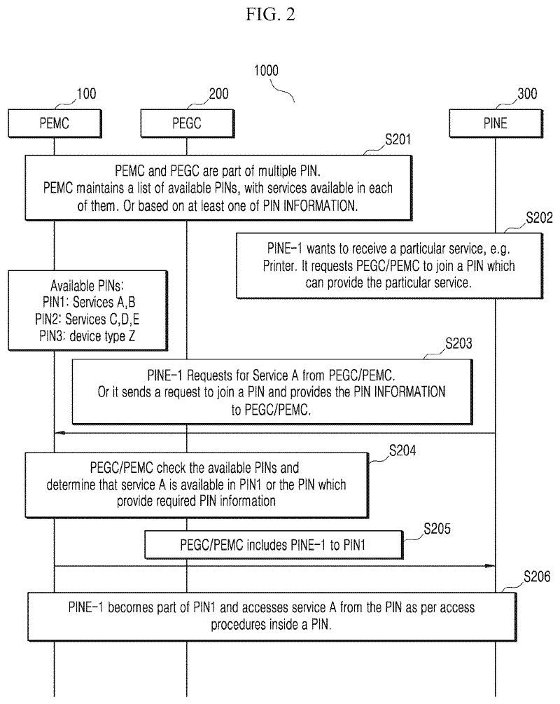

Referring now to the drawings and more particularly to FIGS. 2 through 9, where similar reference characters denote corresponding features consistently throughout the figures, there are shown preferred embodiments.

FIG. 2 illustrating a scenario of identification of the PIN based on service required, according to the embodiments as disclosed herein. Referring to the FIG. 2 considering the proposed method, the information (or PIN information) in this embodiment is defined by at least one of the below:

Type of Service (e.g., IOT, hospital IOT devices)

Type of device (e.g. Printer, thermostat)

Characteristics

Group ID (kind of PIN-ID it wants to join)

Capability (capability like printer etc.)

Plain string configured by a user or the SGC in a PEMC (100) or PEGC (200) or in the PINE (300), when the PINE (300) sends that plain string PEMC or PEGC (200) identifies which PIN the PINE (300) should be added. This plain string can be any configurable text for example it can be an ID or PIN_NAME or PIN_DISCOVERY name etc.

The PINE identifier. PEGC (200)/PEMC (100) can identify the UE (PINE) from this identifier and based on subscription information (received from 5GS or configured by the authorized user) about this PINE (300) the PEGC (200)/PEMC (100) will select the PIN and add this PINE (300) into the respective PIN.

The one or more FQDN/PIN-GW_NAME can uniquely identify Type of devices or type of service or any of the Information (also called PIN information) is configured in the PINE (300). For example the subset of FQDN consists of the Type of devices or type of service or Plain string (PIN_NAME). This pre-configuration can be done by the 5GS using e.g. NAS/AS signalling message or by the authorized user or by any entity in general e.g. PIN server or PEMC.

The steps are as follows:—

In step S201, the PEMC (100) and the PEGC (200) are part of multiple PINs. PEMC (100)/PEGC (200) maintains a list of available PINs, with services available in each of them. PEMC can maintain a list of available PINs based on any of the INFORMATION (also called as PIN INFORMATION in this embodiment). For example the PIN which supports printer service i.e. the PIN which have at least one element who supports printer service.

In step S202, the PINE (300) wants to receive a particular service, e.g. Printer. It requests PEGC (200)/PEMC (100) to join a PIN which can provide the particular service. Similarly based on at least one of the PIN INFORMATION (i.e. type of device/characteristic/type of service etc).

In step S203, the PINE (300) requests PEGC (200)/PEMC (100) to join a PIN. This service type or INFORMATION is indicated by PINE (300) in the registration/attach message/join message, in other words PINE (300) signals at least one of the information (also called as PIN information) to the PEGC (200)/PEMC (100).

In step S204, the PEGC (200)/PEMC (100) check the available PINs and determine that the requested service is available in a particular PIN or based on the at least one of the INFORMATION/PIN information (i.e. example type of device/characteristics) matches a particular PIN. E.g. requested service A is available in PIN1 in FIG. 2.

In step S205, the PEGC (200)/PEMC (100) includes the PINE (300) to the respective which is associated or supports at least one of the PIN information requested by the PINE (300).

In step S206, the first PINE (300a) becomes part of PIN1 and accesses service A from the PIN as per communication procedures within the PIN.

If the PEGC (200)/PEMC (100) determines that requested PIN information by the PINE (300) is not supported in any of the PINs or the PINE (300) is not authorized or not allowed to use the requested PIN information then PEGC (200)/PEMC (100) rejects the join request and indicate to the PINE (300). The PINE (300) should not request for the same PIN information optionally for the implementation dependent time guarded by the timer (the timer value can be pre-configured in the UE or signalled in one of the NAS or AS signalling message) or till the power cycle i.e. switch off and switch on.

The information (or PIN information) in this embodiment is defined by at least one of the below:

Type of Service (IOT, hospital IOT devices)

Type of device (e.g. Printer, thermostat)

Characteristics

Group ID (kind of PIN-ID it wants to join)

Capability (capability like printer etc.)

Plain string configured by user or the 5GC in the PEMC (100) or PEGC or PINE (300), when the PINE (300) sends that plain string PEMC (100) or PEGC (200) identifies which PIN the PINE (300) should be added. This plain string can be any configurable text for example it can be an ID or PIN_NAME or PIN_DISCOVERY name etc. The plain string can also be called as user configured name or CN configured name or it can be given any name with same use.

“Type of Service” can be one of the below or any combination of below, it should be noted that this is not exhaustive list.

eMBB: enhanced Mobile Broadband

URLLC: ultra-reliable low latency communications.

MIoT: massive IoT or IOT

V2X services

High-Performance Machine-Type Communications

Type of device are for e.g. Printer, thermostat also devices which can support “Type of Service” listed above. Characteristics: Characteristics of the devices which can handle “Type of Service” listed above. Group ID (kind of PIN-ID it wants to join). Capability (capability like printer etc.) or the capability of the devices which can support the “type of service” or “type of devices” listed above.

Further, the proposed method provides a scenario of getting subscription parameters from Core Node (CN). The steps are as follows—

Intra PIN.

a-1) first PINE (300a) (i.e., PINE-1) report its capability/services (for e.g. printer)/type of device to the PIN-M (PEMC) (100).

PIN-M/PIN-GW (PEGC) (200) stores it and broadcasts that it has PINE supporting a particular capability/type of device/services (for e.g. printer)

PIN-M/PIN-GW stores the capability/type of device/services mapped to respective PINE optionally keyed in by the user by using user interface or etc. mechanism.

d1. When this respective PINE joins the PIN the PIN-M (PEMC) (100)/PINGW entity can broadcasts that service available.

The first PINE (300a) report its capability/services/type of device (also called as establishment cause) (in general PIN information) to the PIN-GW (PEGC) (200). The PIN-GW stores it.

The second PINE (300b) request PIN-M/PIN-GW for a capability/type of device/services (for e.g. printer) (in general PIN information).

The PIN-M/PIN-M entity will provide FQDN/PINE-NAME to the second PINE (300b).

The PIN-M/PIN-GW will add the second PINE (300b) the respective PIN where particular service is provided (e.g. printer).

Further, the first PINE (300a) and the second PINE (300b) communicate with each other to receive required services.

In S201, the PEMC (100) and the PEGC (200) are part of multiple PIN. The PEMC (100) maintains a list of available PINs, with services available in each of them or based on at least one of PIN information. In S202, the first PINE (300a) wants to receive a particular service, e.g. Printer. The first PINE (300a) requests PEGC (200)/PEMC (100) to join a PIN which can provide the particular service. In S203, the first PINE (300a) requests for the service A from the PEGC (200)/PEMC (100). Alternatively, the first PINE (300a) sends a request to join a PIN and provides the PIN information to the PEGC (200)/the PEMC (100). In S204, the PEGC (200)/PEMC (100) check the available PINs and determines that service A is available in the first PIN or the PIN which provide required PIN information. In S205, the PEGC (200)/PEMC (100) includes first PINE (300a) to the PIN1. In S206, the first PINE (300a) becomes part of PIN1 and accesses service A from the PIN as per access procedures inside a PIN.

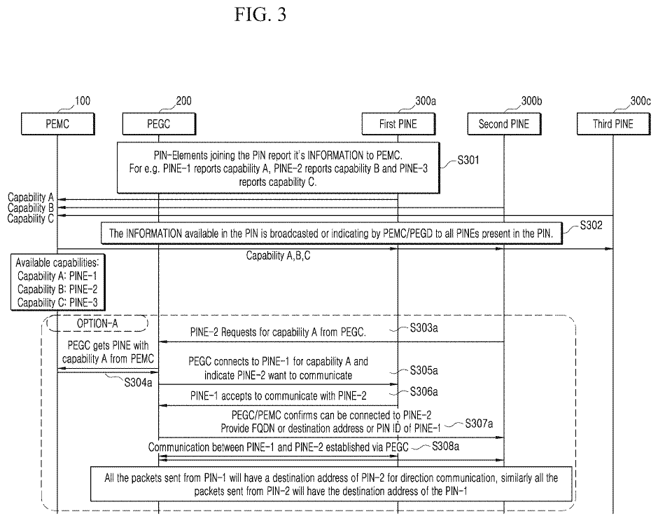

FIG. 3 illustrating a scenario of identification of the PINE (300a) to support service within the PIN, using PEGC (200) as relay for communication between PIN Elements, according to the embodiments as disclosed herein;

Referring to the FIG. 3, the one or more FQDN/PIN-GW_NAME can uniquely identify Type of devices or type of service or any of the Information (also called PIN information) is configured in the PINE (300a). For example the subset of FQDN consists of the Type of devices or type of service or Plain string (PIN_NAME). This pre-configuration can be done by the 5GS using e.g. NAS/AS signalling Messager i.e. in general by any entity (e.g. PIN server or PEMC/PEGC) using a message or by the authorized user.

In steps S301 and S302, PIN-Elements joining the PIN report it's INFORMATION (also called as PIN information) to PEMC (100) or PEGC (200). For e.g. first PINE (i.e., PINE-1) (300a) reports capability A, the second PINE (i.e., PINE-2) (300b) reports capability B and third PINE (i.e., PINE-3) (300c) reports capability C. Capability is just an example this can be one or more of the PIN information also called as information in this embodiment. The INFORMATION available in the PIN is broadcasted or indicated by PEMC (100) or PEGC (200) to all PINEs present in the PIN or by a signalled to the PINE for example at the PIN layer. This information is also stored with PEMC (100) or PEGC (200), along with the PINE-ID with which the information is associated i.e. PINE which supports the PIN information.

### Option A

Step S303a (Optional step): When the PINE (300) receives an indication from PEMC (100)/PEGC (200) about availability of a service/capability, which the PINE (300) needs, it sends a request to PEGC (200)/PEMC (100) for accessing that service/capability. For e.g. the second PINE (300b) requests for capability A from PEGC (200) in the FIG. 2.

In the FIG. 3, its shown as an illustration that the second PINE (300b) requests PEGC (200), the request can also be sent to the PEMC (100) by the second PINE (300b). When one of them receives the request they can co-ordinate and further steps can be executed by one of the PEGC (200) or the PEMC (100) i.e. from Step S304a onwards.

Step S304a—PEGC (200)/PEMC (100) gets the PINE information which has capability A from the PEMC (100). The PEMC (100) provides the PINE information to PEGC (200) if requesting PINE is allowed to access such PIN information example capability/service (as per access rights).

Step S305a—PEGC (200) connects to PINE which has the requested capability and informs it about the service required. E.g. PEGC (200) connects to the first PINE (300a) for capability A. PEGC (200) also indicate the second PINE (300b) wants to communicate. The second PINE (300b) can be identified by PINE-ID or FQDN or some other identifier or some discoverable address.

Step S306a—Optionally, requested PINE accepts to communicate with requesting PINE. In FIG. 3, the first PINE (300a) accepts to communicate with the second PINE (300b).

Step S307a—PEGC (200)/PEMC (100) confirms can be connected to the second PINE (300b), provide FQDN or destination address or PIN ID (in general some identifier) of first PINE (300a).

PEGC (200)/PEMC (100) can indicate to both first PINE (300a) and/or the second PINE (300b) that the communication between the first PINE (300a) and the second PINE (300b) should be using the relay of PEGC (200), should be direct communication or should be via 5GS.

Step S308a—Communication between service requesting PINE and service providing PINE is established via PEGC (200) i.e. PEGC starts acting as a relay. E.g. Connection between the first PINE (300a) and the second PINE (300b) is established via PEGC (200) in the FIG. 3 All the packets sent from PIN-1 will have a destination address of PIN-2 for direction communication, similarly all the packets sent from PIN-2 will have the destination address of the PIN-1.

Similarly if a packet has to be sent to 5GC then PINE will include the destination address of 5GC. The destination address can also be called as discovery address or some identifier to reach the target node.

In other words, as shown in FIG. 3, at S301, the PIN elements (PINE) (300) joining the PIN report it's information to the PEMC (100). In an example, the third PINE (300c) reports capability A, the second PINE (300b) reports capability B and the first PINE (300a) reports capability C. At S302, the information available in the PIN is broadcasted or indicating by PEMC (100)/PEGC (200) to all PINEs (300) present in the PIN. At S303, the second PINE (300b) requests for capability A from the PEGC (200). At S304a, the PEGC (200) gets PINE with capability A from PEMC (100). At S30Sa, the PEGC connects to the first PINE (300a) for capability A and indicate PIN-2 want to communicate. At S306a, the first PINE (300a) accepts to communicate with the second PINE (300b). At S307a, the PEGC (200)/PEMC (100) is connected to the second PINE (300b) provide FQDN or destination address or PIN ID of the first PINE (300a). At S308a, the communication between the first PINE (300a) and the second PINE (300b) is established via the PEGC (200). All the packets sent from PIN-1 will have a destination address of PIN-2 for direction communication, similarly all the packets sent from PIN-2 will have the destination address of the PIN-1.

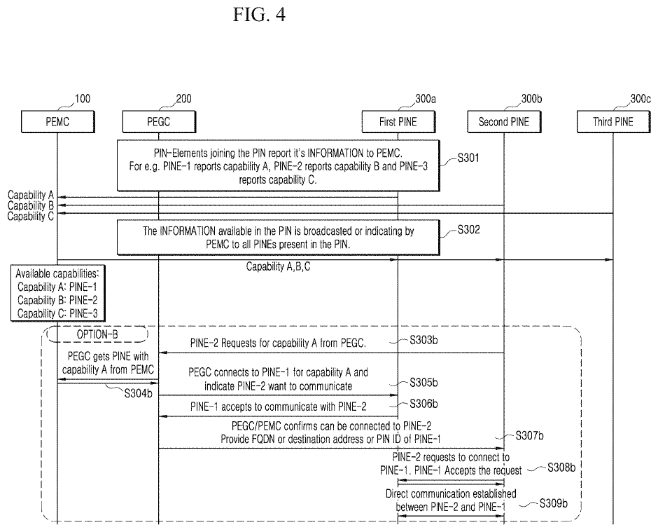

FIG. 4 illustrating a scenario identification of the PINE (300) to support service within the PINE (300), using direct communication between PIN Elements, according to the embodiments as disclosed herein.

Referring to the FIG. 4 considering the proposed method, illustrates the scenario of if the direct communication between 2 PINEs is allowed. The steps are as follows—

### Option B

Step S303b (Optional step): When a PINE (300) receives an indication from PEMC (100)/PEGC (200) about availability of a service/capability which the PINE (300) needs, it sends a request to PEGC (200)/PEMC (100) for accessing that service/capability. For e.g. the second PINE (300b) requests for capability A from PEGC (200) in the FIG. 4.

In the FIG. 4 its shown as an illustration that the second PINE (300b) requests PEGC (200), the request can also be sent to PEMC (100) by the second PINE (300b). When one of them receives the request they can co-ordinate and further steps can be executed by one of the PEGC (200) or PEMC (100) i.e. from step S304b onwards.

Step S304b—PEGC (200)/PEMC (100) gets the PINE information which has capability A from PEMC (100). The PEMC (100) provides the PINE information to PEGC (200) if the requesting PINE is allowed to access such capability/service (as per access rights).

Step S305b—PEGC (200) connects to PINE (300) which has the requested capability and informs it about the service required. E.g. PEGC connects to the first PINE (300a) for capability A. PEGC (200) also indicates the second PINE (300b) wants to communicate. The second PINE (300b) can be identified by PINE-ID or FQDN or some other identifier.

Step S306b—Optionally, requested PINE accepts to communicate with requesting PINE. In FIG. 3, the first PINE (300a) accepts to communicate with the second PINE.

Step S307b—PEGC (200)/PEMC (100) confirms that the first PINE (300a) can be connected to the second PINE (300b), Provide FQDN or destination address or PIN ID (in general some identifier) of the first PINE (300a) to the second PINE (300b).

Step S308b—the second PINE requests to connect to the first PINE (300a). The first PINE (300a) accepts the request from the second PINE (300b).

PEGC (200)/PEMC (100) can indicate to both the first PINE (300a) and/or second PINE (300b) that the communication between the first PINE (300a) and the second PINE (300b) should be using the relay of PEGC (200), should be direct communication or should be via 5GS.

Step S309b—Direct communication established between service requesting PINE (300) and service providing PINE. E.g. between the second PINE (300b) and the first PINE (300a) in FIG. 3.

All PIN-Elements (300a-300c) will be configured with one or more PIN-M IDs.

### Flow-1

PINE (300) will connect to PIN-M. PIN-M will then download what is the PIN-ID or PIN-GW ID into PINE (300).

### Flow-2

PINE (300) can be pre-configured with one or more PIN-GW. PINE will connect to that FQDN/PIN-GW_NAME—or from the user. PIN_E will register with PIN_GW. based on this name PINE will register with PIN-GW.PIN_E will register with 5GC via PIN_GW.

Further, the proposed method provides a scenario of getting subscription parameters from Core Node (CN). The steps are as follows—

Intra PIN.

a-1) the first PINE (300a) report its capability/services (for e.g. printer)/type of device to the PIN-M.

PIN-M/PIN-GW (200) stores it and broadcasts that it has PINE supporting a particular capability/type of device/services (for e.g. printer)

PIN-M/PIN-GW (200) stores the capability/type of device/services mapped to respective PINE optionally keyed in by the user by using user interface or etc. mechanism.

When this respective PINE joins the PIN the PIN-M (PEMC) (100)/PINGW entity can broadcasts that service available.

a-2) the first PINE report its capability/services/type of device (also called as establishment cause) (in general PIN information) to the PIN-GW (PEGC) (200). PIN-GW (200) stores it.

b-1) The second PINE (300b) request PIN-M/PIN-GW for a capability/type of device/services (for e.g. printer) (in general PIN information).

c-1) PIN-M/PIN-M entity will provide FQDN/PINE-NAME to the second PINE (300b)

or PIN-M/PIN-GW (200) will add the second PINE (300b) the respective PIN where particular service is provided (e.g. printer)

d-1) Further the first PINE (300a) and the second PINE (300b) communicate with each other to receive required services.

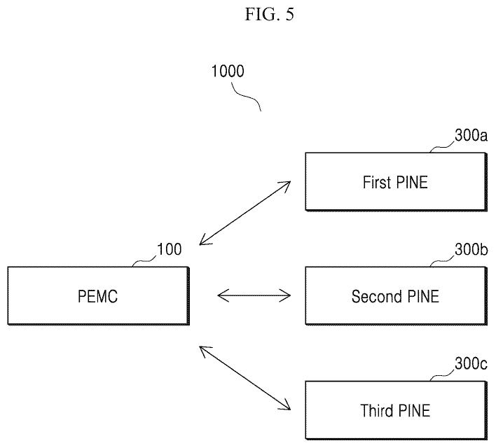

In other words, as shown in FIG. 4, At S301, the PIN elements (300a-300c) joining the PIN report. At S302, the information available in the PIN is broadcasted or indicating by PEMC (100) to all PINEs present in the PIN. At S303b, the second PINE (300b) requests for capability A from the PEGC (200). At S304b, the PEGC (200) gets the PINE with capability A from the PEMC (100). At S305b, the PEGC (200) connects to the first PINE (300a) for capability A and indicate the second PIN want to communicate. At 6, the first PINE (300a) accepts to communicate with the second PINE (300b). At S307b, the PEGC (200)/PEMC (100) is connected to the second PINE (300b) and provide FQDN or destination address or PIN ID of the first PINE (300a). At S308b, the second PINE requests to connect to the first PINE (300a). The first PINE (300a) accepts the request. At S309b, the direct communication is established between the second PINE (300b) and the first PINE (300a).FIG. 5 illustrates an overview of PIN (1000) for handling PIN discovery and communication, according to the embodiments as disclosed herein. In an embodiment, the PIN (1000) includes the PEMC (100) and the PINEs (300a-300c).

The PEMC (100) receives the request message to join the at least one PIN from the PINE (300). The request message includes the PIN information to communicate a service or a device type supported by the at least one PIN. The PIN information includes at least one of a) supported service or device type indicating particular service supported by the PINE (300), b) the requested service or device type indicating the requested service that the PIN shall support and in which the PINE (300) has to be added, c) a group identifier configured by the authorized user or the network device, wherein the group identifier indicates the request message to join the at least one PIN which supports a particular group, d) a user defined name configured by the authorized user or the network device at the PINE (300), wherein user defined name identifies which PIN (1000) the PINE (300) should be added based on the user defined name, and e) discoverability criteria, wherein the PINE (300) is allowed to be discovered when requested for at least one of a specific service, a specific group ID, a specific user defined name, and a specific time.

Further, the PEMC (100) determines that the requested service or device type is supported by the at least one PIN from a plurality of PINs based on the PIN information. Further, the PEMC (100) selects the at least one PIN from the plurality of PINs when the requested service or device type is supported by the at least one PIN form the plurality of PINs. Further, the PEMC (100) adds the PINE (300) to the at least one PIN (1000) to communicate the requested service or device type by authorizing the PINE (300). Further, the PEMC (100) stores the PIN information after adding the PINE to the at least one PIN (300). Further, the PEMC (100) sends an accept message to the PINE (300). The accept message includes PEGC information of at least one PEGC (200) through which the PINE communicatees the requested service or device type from the at least one PIN.

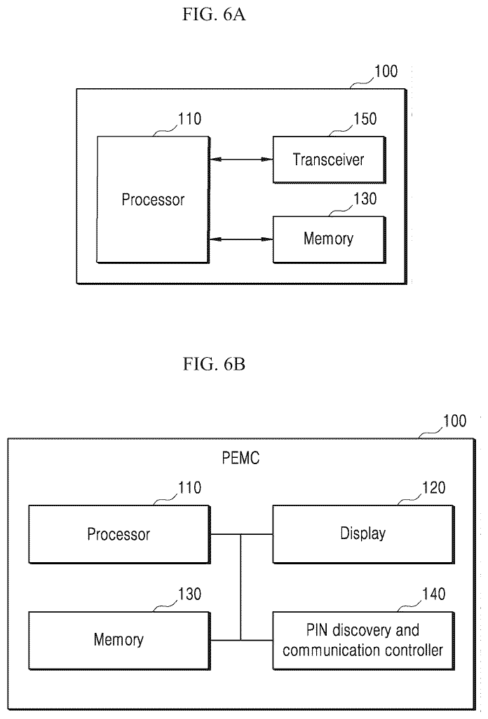

FIG. 6A is a diagram illustrating a PEMC (100) according to an embodiment of the present disclosure. Referring to the FIG. 6A, the PEMC (100) may include a processor 110, a transceiver (150) and a memory (130). However, all of the illustrated components are not essential. The PEMC (100) may be implemented by more or less components than those illustrated in FIG. 6a. For example, the PEMC (100) may include a PIN discovery and communication controller.

In addition, the processor (110) and the transceiver (150) and the memory (130) may be implemented as a single chip according to an embodiment. The aforementioned components will now be described in detail.

The processor (110) may include one or more processors or other processing devices that control the proposed function, process, and/or method. Operation of at least one of the PEMC in this disclosure may be implemented by the processor (110).

The transceiver 150 may include a RF transmitter for up-converting and amplifying a transmitted signal, and a RF receiver for down-converting a frequency of a received signal. However, according to an embodiment, the transceiver 150 may be implemented by more or less components than those illustrated in components.

The transceiver (150) may be connected to the processor (110) and transmit and/or receive a signal. The signal may include control information and data. In addition, the transceiver (150) may receive the signal through a wireless channel and output the signal to the processor (110). The transceiver (150) may transmit a signal output from the processor (110) through the wireless channel.

The memory (130) may store the control information or the data included in a signal obtained by the PEMC (100). The memory (130) may be connected to the processor (110) and store at least one instruction or a protocol or a parameter for the proposed function, process, and/or method. The memory (130) may include read-only memory (ROM) and/or random access memory (RAM) and/or hard disk and/or CD-ROM and/or DVD and/or other storage devices.

FIG. 6B shows various hardware components of the PEMC (100), according to the embodiments as disclosed herein. In an embodiment, the PEMC (100) includes a processor (110), a display (120), a memory (130) and a PIN discovery and communication controller (140). The processor (110) is coupled with the display (120), the memory (130) and the PIN discovery and communication controller (140).

The PIN discovery and communication controller (140) receives the request message to join the at least one PIN from the PINE (300). The message includes the PIN information to communicate the service or the device type supported by the PIN. Further, the PIN discovery and communication controller (140) determines whether the requested service or device type is supported by at least one PIN from the plurality of PINs based on the PIN information. Further, the PIN discovery and communication controller (140) selects the at least one PIN from the plurality of PINs when the requested service or device type is supported by the at least one PIN form the plurality of PINs. Further, the PIN discovery and communication controller (140) adds the PINE (300) to the at least one PIN to communicate the requested service or device type. Further, the PIN discovery and communication controller (140) sends the accept message to the PINE (300).

The PIN discovery and communication controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 6B shows various hardware components of the PEMC (100) but it is to be understood that other embodiments are not limited thereon. In other embodiments, the PEMC (100) may include less or more number of components. Further, the labels or names of the components are used only for illustrative purpose and does not limit the scope of the disclosure. One or more components can be combined together to perform same or substantially similar function in the PEMC (100).

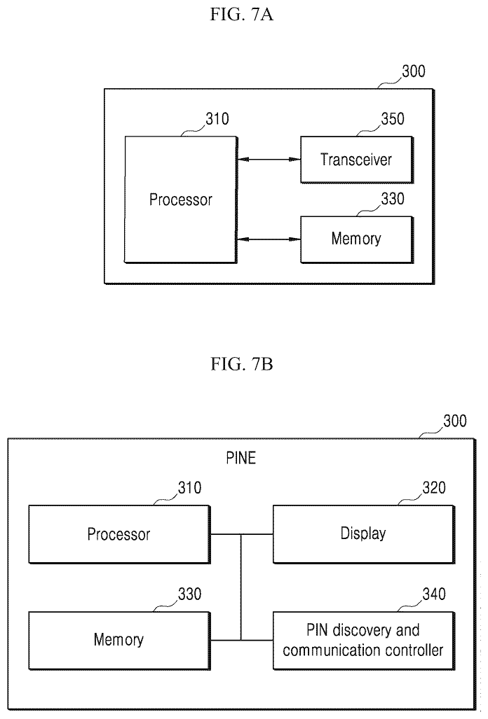

FIG. 7A is a diagram illustrating a PINE (300) according to an embodiment of the present disclosure.

Referring to the FIG. 7A, the PINE (300) may include a processor (310), a transceiver (350) and a memory 330. However, all of the illustrated components are not essential. The PINE (300) may be implemented by more or less components than those illustrated in FIG. 7A. For example, the PINE may include a PIN discovery and communication controller (340).

In addition, the processor (310) and the transceiver (350) and the memory (330) may be implemented as a single chip according to another embodiment. The aforementioned components will now be described in detail.

The processor (310) may include one or more processors or other processing devices that control the proposed function, process, and/or method. Operation of the PINE (300) aforementioned in this disclosure may be implemented by the processor (310).

The transceiver (350) may include a RF transmitter for up-converting and amplifying a transmitted signal, and a RF receiver for down-converting a frequency of a received signal. However, according to another embodiment, the transceiver (350) may be implemented by more or less components than those illustrated in components.

The transceiver (350) may be connected to the processor (310) and transmit and/or receive a signal. The signal may include control information and data. In addition, the transceiver (350) may receive the signal through a wireless channel and output the signal to the processor (310). The transceiver (350) may transmit a signal output from the processor (310) through the wireless channel.

The memory (330) may store the control information or the data included in a signal obtained by the PINE (300). The memory (330) may be connected to the processor 510 and store at least one instruction or a protocol or a parameter for the proposed function, process, and/or method. The memory (330) may include read-only memory (ROM) and/or random access memory (RAM) and/or hard disk and/or CD-ROM and/or DVD and/or other storage devices.

FIG. 7B shows various hardware components of the PINE (300), according to the embodiments as disclosed herein. In an embodiment, the PINE (300) includes a processor (310), a display (320), a memory (330) and a PIN discovery and communication controller (340). The processor (310) is coupled with the display (320), the memory (330) and the PIN discovery and communication controller (340).

The PIN discovery and communication controller (340) configures the PIN information from the network device (e.g. PIN server/PEMC or any other entity managing the PIN) or the authorized user. Further, the PIN discovery and communication controller (340) sends the request message to join at least one PIN to the PEMC (100). The message includes the PIN information to communicate the service or device type supported by at least one PIN. Further, the PIN discovery and communication controller (340) receives the accept message confirming addition of the PINE (300) into the at least one PIN. The accept message comprises PEGC information of at least one PEGC (200) through which the PINE communicatees the requested service or device type from the at least one PIN. Further, the PIN discovery and communication controller (340) communicates with the requested service or device type from the at least one PIN through the at least one PEGC (200) based on the PEGC information.

The PIN discovery and communication controller (340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (310) is configured to execute instructions stored in the memory (330) and to perform various processes. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

Although the FIG. 7B shows various hardware components of the PINE (300) but it is to be understood that other embodiments are not limited thereon. In other embodiments, the PINE (300) may include less or more number of components. Further, the labels or names of the components are used only for illustrative purpose and does not limit the scope of the disclosure. One or more components can be combined together to perform same or substantially similar function in the PINE (300).

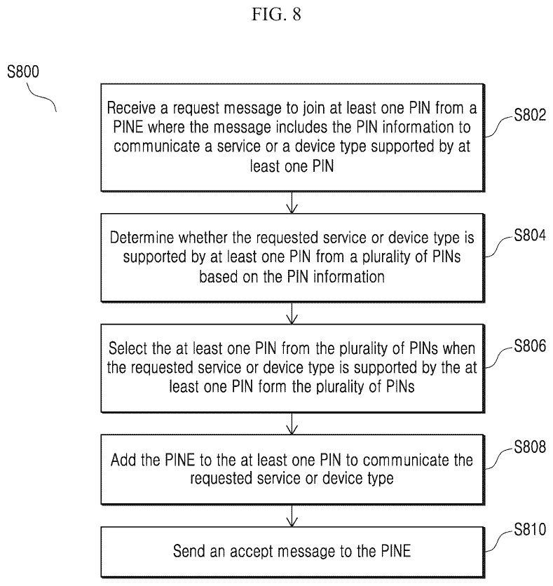

FIG. 8 is a flow chart (800) illustrating a method, implemented by the PEMC (100), for PIN discovery and communication in the PIN, according to the embodiments as disclosed herein. The operations (S802-S810) are handled by the PIN discovery and communication controller (140).

At S802, the method includes receiving the request message to join the at least one PIN from the PINE (300). The message includes the PIN information to communicate the service or the device type supported by the at least one PIN. At S804, the method includes determining whether the requested service or device type is supported by the at least one PIN from a plurality of PINs based on the PIN information. At S806, the method includes selecting the at least one PIN from the plurality of PINS when the requested service or device type is supported by the at least one PIN form the plurality of PINs. At S808, the method includes adding the PINE (300) to the at least one PIN to communicate the requested service or the device type. At S810, the method includes sending the accept message to the PINE (300).

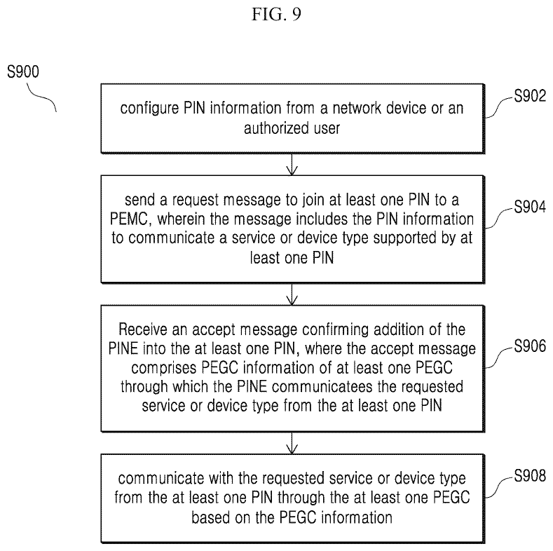

FIG. 9 is a flow chart (S900) illustrating a method, implemented by the PINE (300), for PIN discovery and communication in the PIN (1000), according to the embodiments as disclosed herein. The operations (S902-S908) are handled by the PIN discovery and communication controller (340).

At S902, the method includes configuring the PIN information from the network device or the authorized user. At S904, the method includes sending the request message to join the at least one PIN to the PEMC (100). The message includes the PIN information to communicate the service or device type supported by the at least one PIN. At S906, the method includes receiving the accept message confirming addition of the PINE (300) into the at least one PIN, where the accept message comprises PEGC information of at least one PEGC (200) through which the PINE (300) communicatees the requested service or device type from the at least one PIN. At S908, the method includes communicating the requested service or device type from the at least one PIN through the at least one PEGC (200) based on the PEGC information.

The various actions, acts, blocks, steps, or the like in the flow charts (S800 and S900) may be performed in the order presented, in a different order or simultaneously. Further, in some embodiments, some of the actions, acts, blocks, steps, or the like may be omitted, added, modified, skipped, or the like without departing from the scope of the disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1-12. (canceled)

13. A method performed by a PIN element with management capability (PEMC) for communication in a personal IOT network (PIN), the method comprising:
receiving, from a PIN Element (PINE), a request message to join a PIN, wherein the request message includes an ID of the PINE and a PIN ID which is an identifier of the PIN that the PINE wants to join;
performing an authorization procedure to determine whether the PINE has authorized to join the PIN; and
sending, to the PINE, an accept message.

14. The method of claim 13, wherein the request message further includes information about required services for identifying one or more services requested by the PINE.

15. The method of claim 13, wherein the request message further includes information about supported services for identifying one or more services that the PINE can provide.

16. The method of claim 13, wherein the request message further includes device type information.

17. The method of claim 13, wherein the accept message includes PIN element with gateway capability (PEGC) information.

18. A PIN element with management capability (PEMC) for communication in a personal IOT network (PIN), the PEMC comprising:
a memory;
a PIN discovery and communication controller; and
a processor coupled to the memory and the PIN discovery and communication controller is configured to:
receive, from a PIN Element (PINE), a request message to join a PIN, wherein the request message includes an ID of the PINE and a PIN ID which is an identifier of the PIN that the PINE wants to join,
perform an authorization procedure to determine whether the PINE has authorized to join the PIN, and
send, to the PINE, an accept message.

19. The PEMC of claim 18, wherein the request message further includes information about required services for identifying one or more services requested by the PINE.

20. The PEMC of claim 18, wherein the request message further includes information about supported services for identifying one or more services that the PINE can provide.

21. The PEMC of claim 18, wherein the request message further includes device type information.

22. The PEMC of claim 18, wherein the accept message includes PIN element with gateway capability (PEGC) information.
